(19) United States
(12) Patent Application Publication
(10) Pub. No.: US 2005/0174335 A1
(43) Pub. Date: Aug. 11, 2005

(54) Resistive touchscreen with programmable display coversheet

(75) Inventors: Joel Christopher Kent, Fremont, CA (US); Paul M. Adriani, Palo Altp, CA (US)

Correspondence Address: Tyco Electronics Corporation, MS R20/2B, 307 Constitution Drive, Menlo Park, CA, 94025-1164, US

(73) Assignee: Elo TouchSystems, Inc., Fremont, CA (US)

(21) Appl. No.: 10/776,110

(22) Filed: Feb. 10, 2004

(51) Int. Cl. G09G 5/00

(52) U.S. Cl. 345/173

(57) ABSTRACT

A resistive touchscreen having a programmable display, such as an emissive display matrix of organic light-emitting diodes, or a reflective electronic paper display, built into the coversheet. The touchscreen may be of any resistive type, including 4-wire, 5-wire, and diode 3-wire. A touch/display system is thus provided in which there is little or no degradation of the displayed image due to image transmission through the internal touch sensor components, and in which the internal touch sensor components may be constructed of opaque materials.

### FIELD OF INVENTION

The present invention relates to touchscreens; more particularly, to resistive touchscreens with programmable display coversheets.

### BACKGROUND AND RELATED ART

Touchscreens are the input device of choice for an increasing variety of computer-operated devices and applications. A conventional touchscreen is a transparent input device that can sense the two-dimensional position of the touch of an object, such as a finger or a stylus. Touchscreens are placed over display devices, such as cathode-ray-tube monitors and liquid crystal displays, to form touch-display systems. For example, touch display systems are used for applications such as restaurant order entry systems, industrial process control applications, automated teller machines, personal digital assistant (PDA) devices, interactive museum exhibits, airline check-in machines, etc.

Touchscreens have been manufactured using a number of different technologies, such as resistive (e.g., 4-wire, 5-wire, 9-wire, 3-wire diode), capacitive, acoustic, and infra-red (IR). Resistive touchscreens, such as the AccuTouch™ product line of Elo TouchSystems, Inc. of Fremont, Calif., have been widely accepted for many touchscreen applications. In a resistive touchscreen, mechanical pressure from a finger or stylus causes a (typically plastic membrane) coversheet to flex and make physical contact with an underlying (typically glass) substrate. The substrate is coated with a resistive layer upon which voltage gradients are excited. In a 5-wire resistive touchscreen, associated electronics can sequentially excite gradients in both the X and Y directions via electrical connections to the four comers of the substrate. The underside of the coversheet has a conductive coating which provides an electrical connection between the touch location and voltage sensing electronics. 4-wire resistive touchscreens alternate between exciting a voltage gradient on the substrate resistive coating and exciting an orthogonal voltage gradient on the coversheet coating in order to obtain the respective X and Y coordinates.

It will be appreciated that the “resistivity” of a material may be equally (albeit conversely) described in terms of its “conductivity;” i.e., a material that is described as having a relatively high resistivity may also be described as having a relatively low conductivity. Notably, if the respective substrate and coversheet coatings were both perfectly conductive, the touchscreen would not function. A significant resistivity (e.g., in a range of 100 to 1000—or even greater—Ohms/square) of the coatings is essential for the generation of voltage gradients at reasonable levels of power consumption. Thus, the terms “conductive” and “resistive,” as used in the present specification and in the appended claims, both refer to the ability to conduct at least some current in response to an applied voltage. It will also be appreciated that, as used herein, the terms “layer” and “coating” refer to functionally similar, if not identical, physical structures and should be considered generally interchangeable in the present specification and claims. Further details regarding resistive touchscreens may be found in U.S. Pat. No. 6,163,313, which is fully incorporated herein by reference.

A performance advantage of resistive touchscreens over other touchscreen technologies is their relatively high touch sensitivity for a sharp-tipped passive stylus, such as a small, plastic stylus, a long fingernail or the corner of a credit card. Also, resistive touchscreens consume little to zero power in “sleep” or “detect” mode, in which they function as simple on/off membrane switches. Power need only be consumed when touches are present and voltage gradients are generated for coordinate information. Thus, resistive touchscreens are power efficient, making them highly attractive as a touchscreen technology for battery-powered (e.g., hand held) devices, such as PDAs. A main disadvantage of resistive touchscreens, however, is their degradation of the display image quality due to the multiple air/solid interfaces that the optical image must pass through, as well as optical absorption and haze from light scattered within the various material layers of the touchscreen, and glare from ambient light reflecting from the multiple air/solid interfaces and/or scattered within the various material layers of the touchscreen. The use of a degenerate semi-conductor, such as indium tin oxide (ITO), provides a means to produce relatively transparent conductive films. However, they still cause significant optical transmission and reflective losses on the display image. Additionally, because the conductive coatings must be transparent, less expensive and/or better performing, albeit more opaque, resistive coatings, such as conductive polymers or thin metal layers are not commercially popular for resistive touchscreens, and fully opaque, resistive coatings, such as thicker metal layers or composites cannot be used.

### SUMMARY OF THE INVENTION

In accordance with a general aspect of the invention, a resistive touchscreen is provided with a coversheet having a programmable display, i.e. a display having an image that can be controlled and changed via electronic signals. Because the coversheet includes a programmable display, the substrate and internal (i.e., “touch sensor”) components of the touchscreen need not be transparent. For example, conductive coatings with poor optical transmission properties, e.g., relatively opaque conductive polymers or thin metal layers may be used. Further, fully opaque, resistive coatings, such as thicker metal layers or composites, may be used.

In one embodiment, the touchscreen comprises a substrate having a first conductive region on a top surface thereof, and a coversheet having a second conductive region on a bottom surface thereof, the coversheet bottom surface facing, and spaced apart from, the substrate top surface. The coversheet has a programmable display visible from its top surface, the coversheet (and display) being collectively sufficiently flexible that a force applied to the coversheet causes the first and second conductive regions to make electrical contact in a location proximate the applied force.

The programmable display may comprise a dynamic, e.g., video display, a static, e.g., array of icons display, or some combination thereof. The programmable display may be emissive, such as a matrix of organic light-emitting diodes (“OLEDs”), as well as reflective, such as electronic paper elements.

Other and further aspects, embodiments and features of the invention will be evident from the following detailed description and illustrated embodiments, which are intended to demonstrate, but not limit, the invention.

### BRIEF DESCRIPTION OF THE FIGURES

The figures illustrate the design and utility of embodiments of the invention, in which:

FIG. 1 is a sectional side view of an exemplary resistive touchscreen having a coversheet with a programmable display;

FIG. 2 is a partial plan view of one embodiment of the coversheet of the touchscreen of FIG. 1, wherein a matrix of OLEDs form an emissive programmable display embedded in the coversheet; and

FIG. 3 is a sectional side view of an OLED element in the embodiment of FIG. 2.

### DETAILED DESCRIPTION OF THE ILLUSTRATED EMBODIMENTS

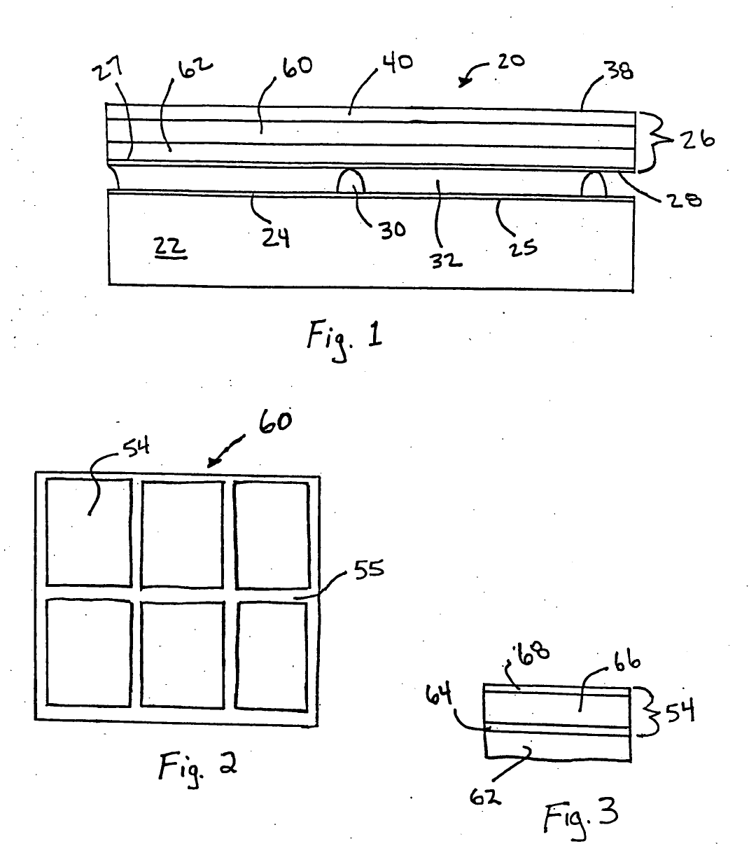

FIG. 1 illustrates a resistive touchscreen 20, which generally comprises a substrate 22 and a coversheet 26. The touchscreen 20 can be any type of resistive touchscreen, including but not limited to 4-wire, 5-wire, or 3-wire diode. The substrate 22 has a top surface 25 with a conductive coating 24 formed thereon. The coversheet 26 has a bottom surface 27 having a conductive coating 28 formed thereon. It will be appreciated that, in alternate embodiments, the substrate top surface 25 and/or coversheet bottom surface 27 may be provided with respective conductive/resistive regions through means other than the coatings 24 and 28, such as, e.g., by particle implantation. It will also be appreciated that the various layers of the touchscreen 20 are not drawn to scale in the figures., which are for illustrative purposes only.

The coversheet 26 has an outward facing (or top) surface 38, from which a programmable display 60 is visible. In this manner, the touchscreen 20 comprises an interior touch sensor (conductive layers 24 and 28) that underlies an exterior programmable display 60 positioned in registration with the touch sensor such that, when elements displayed by the display 60 are touched, the touch sensor determines a two-dimensional position of the touch on the display 60. As used herein, a programmable display generally refers to a display capable of generating an image that can be controlled and changed via electronic signals. The programmable display 60 may be an emissive display. Alternatively, in embodiments especially suited for power sensitive applications, the programmable display 60 may be a reflective display that depends upon reflected ambient light. Whether emissive or reflective, the programmable display 60 may be a video display formed by a (traditionally rectangular) array of pixels for the generation of arbitrary images; a static display, such as an array of icons; or some combination thereof.

More particularly, the programmable display 60 generally comprises an array (or matrix) of display elements (described in greater detail below) formed or otherwise positioned on a flexible (e.g., glass) substrate 62. Optionally, a transparent (e.g., plastic) protective layer 40 overlays the display 60. Because a hard pointed stylus may be damaging to the display elements, it may be desirable that the protective layer 40 is relatively thick (yet soft). If desirable, the material of the protective layer 40 may be selected to give the coversheet surface a “paper-like” feel as a writing surface. It may also be desirable to make the protective top layer 40 replaceable, e.g., a releasable liner.

The coversheet 26 is sufficiently flexible, such that a force applied to the top surface 38, e.g., by a finger or a stylus, causes the conductive coating 28 on its bottom surface 27 to make electrical contact with the conductive coating 24 of the substrate 22 in a location proximate the applied force. As used herein and in the claims, the term “flexible” does not necessarily require that the coversheet is constructed only of materials that are ordinarily considered to be elastic or otherwise deformable, although such properties are possible. What matters is that the respective coversheet component layers (28, 62, 60, 40) collectively have sufficient play or “flex” that they may be readily moved against the substrate 22 to result in electrical contact of the respective conductive coatings 28 and 24, without undue application of force being necessary, and without undue stress and wear on the coversheet components that can lead to failure. It should be readily apparent that this overall flexibility of the coversheet may be achieved despite having certain components of the coversheet, such as glass layers, made of materials not ordinarily considered to be “flexible.”

Control circuitry (not illustrated) is provided to identify in a conventional fashion (depending on the type of resistive touchscreen) the two dimensional (X and Y) coordinates of the location of a force applied to the coversheet 26, whenever electrical contact is made between of the conductive coatings 24 and 28. In a 4-wire type, a first voltage gradient is applied to the first conductive region 24 for a first position coordinate measurement, and a second voltage gradient is applied to the second conductive region 28 for a second position coordinate measurement. In a 5-wire type, alternating voltage gradients are applied to the first conductive region 24 for determining both the first and second position coordinate measurements. A 3-wire diode type is similar to a 5-wire type, but further including a plurality of diodes (not shown) connected to the first conductive region 24. The same or separate control circuitry is also coupled to the programmable display 60 for operating same.

In the illustrated embodiment, a plurality of conventional (non-conductive) mechanical spacer elements 30 are used to maintain an isolating gap 32 between the respective conductive coatings 24 and 28 in the absence of any force being applied to the coversheet 26. The coversheet 26 is preferably sufficiently resilient such that it will return to its spaced position relative to the substrate 22 in an absence of any force being applied. It will be apparent that other mechanisms are possible for maintaining electrical isolation of the conductive coatings 24 and 28 in the absence of an applied force to the coversheet 26. For example, in an alternate embodiment (not shown), the coversheet 26 can be placed under tension and suspended over the substrate 22, much like a trampoline, so that in the absence of a touch, electrical isolation of the conductive coatings 24 and 28 is maintained even when no spacer elements 30 are provided.

The touchscreen 20 of this embodiment may be used as a touch/display system in a number of applications. By way of example, the touchscreen 20 could be used to support a graphical user interface (GUI), such as those in widespread use in PDAs and personal computers. To the operating system (not shown), the touchscreen 20 and its associated controller electronics typically functions as an input (i.e., “mouse”) device, allowing a user to “click” on icons, drag cursors about, etc. The operating system may communicate this touch-input information to application code so that it can respond appropriately, such as generating or updating a displayed image.

For example, an image generated by the display 60 may ask for a user input, and a subsequent image is based at least in part on the user input. By way of another example, a displayed image may change in response to the detection of a force on the coversheet 26, e.g., to change from an “idle” mode to a mode in which user inputs may be queried and received by the touchscreen 20. As with other display applications, associated electronics (not shown) in embodiments of the invention receive image information from the operating system and generate appropriate drive signals for the display 60. Of course, there is no requirement that the touch display system of this or any other embodiment be used with standard operating systems, and many options are available for custom versions of the associated electronics and software.

With reference to FIG. 2, in one embodiment, the programmable display 60 is an emissive display formed by a matrix of top-emitting OLEDs 54 embedded in a flexible display layer 55. The OLEDs 54 may be prefabricated and then mounted on the substrate 62, or they may be fabricated directly onto the substrate 62 as part of the coversheet construction. The OLEDs 54 are preferably thin and flexible enough to flex with the coversheet 26, while still being sufficiently rugged to survive constant poking and flexing during use. One possible construction of OLEDs 54 for use in emissive display embodiments of the invention is described in “Flexible Organic LEDs”, Weaver et al., Information Display 5&6, pp. 26-29, 2001, which is fully incorporated herein by reference. As described in Weaver et al., flexible OLEDs have been developed by Universal Display Corp., Ewing, N.J., USA, and are conformable, light weight, thin profile, and have inherent impact resistance.

As shown in FIG. 3, the OLEDs 54 generally comprise a thin, conductive anode layer 64 on the substrate 62. A stack of organic layers 66 having a thickness on the order of 150 nm is deposited by vacuum sublimation or other vapor-deposition technique on the anode layer 64. A transparent conductive cathode coating 68 is deposited over the top of the organic layer stack 66. In one embodiment, the transparent cathode is composed of a thin metal-injecting contact capped with ITO. As pointed out in Weaver et al., a flexible top-emitting OLED pixel with an area of 5 mm² has sufficient flexibility that it may be wrapped around a cylindrical body with a curvature radius as little as approximately 5 mm, which is more than enough flexibility needed for a touchscreen coversheet.

It may be desired that that the substrate 62 be made of a material (or composite materials) that are moisture and air barriers, such as glass. For example, in one embodiment, the substrate 62 is made of glass and has a thickness of about 200 microns or less. As described in Weaver et al., the OLEDs 54 can alternatively be grown on barrier-coated flexible substrates with optical performance that is comparable or superior to similar OLED devices fabricated on conventional glass substrates. The OLEDs 54 are further encapsulated in a flexible, non-conductive, transparent polymer material 55. Suitable electrical connections (not shown), such a traces formed on the substrate 62, are provided to form respective electrical connections from the control circuitry (and a power source) to the various OLEDs 54.

It should be appreciated that other types of emissive displays may be used in embodiments of the invention. The displays may be fabricated or mounted on an exterior surface of the coversheet 26, or otherwise embedded therein, so long as the display is visible from the exterior surface. It will be appreciated that such emissive displays, including displays employing OLEDs, need not necessarily be highly flexible, as is often the expectation for a “flexible display”, so long as they are sufficiently thin to allow the slight deformation needed for overall touch sensor functionality of the coversheet 26.

In alternate embodiments, reflective displays—such as “electronic paper” displays—may be used for implementing the programmable display 60. As with emissive displays, such reflective displays may be fabricated or mounted on an exterior surface of the coversheet 26, or otherwise embedded therein, so long as the display is visible from the exterior surface. As is the case with emissive displays, such reflective displays also need not necessarily be highly flexible, so long as they are sufficiently thin to allow the slight deformation needed for overall touch sensor functionality of the coversheet 26.

As used herein, the term ‘electronic paper’ is intended to broadly include any electronically controlled reflective display that can be fabricated in the form of a thin, preferably flexible, sheet. By way of non-limiting examples, there are at least three distinct reflective display technologies being developed that may be used in reflective display embodiments of the programmable display 60. One is that developed by Royal Philips Electronics (“Philips”) based on “electrowetting.” As of the submission date of the present application, detailed information on Philips' electrowetting technology may be found using links from www.research.Philips.com/informationcenter/Global/FArticleDetail.asp?|ArticleId=2817. One such link is to an article entitled, “Video-speed electronic paper based on electrowetting,” Hayes et al., Nature Vol. 425, pp. 383-385, 25 Sep. 2003, which provides a scientifically rigorous presentation of electrowetting technology, and which is fully incorporated herein by reference.

Another suitable electronic paper technology is an electrophoresis display being develop by E ink (www.eink.com), based on a proprietary material that they refer to as “electronic ink.” The principle of operation is explained at the web site http://www.eink.com/technology/index.html, the content of which is fully incorporated herein by reference. Another article, “Flexible active-matrix electronic ink display,” Chen et al., Nature Vol. 423, p. 136, 8 May 2003, which is fully incorporated herein by reference, describes in detail an embodiment of an electronic ink display developed by E ink and suitable for reflective display embodiments of the present invention. As described in Chen et al., one such display comprises electronic ink elements formed on a bendable active-matrix-array sheet. The display is preferably less than 0.3 mm thick, has a high pixel density (e.g., 160 pixels×240 pixels) and resolution, e.g., 96 pixels per inch (ca. 38 pixels per cm), and can be bent to a radius of curvature of as little as 1.5 cm without any degradation in contrast.

Still another suitable electronic paper technology for use in reflective display embodiments of the invention is an electrogyroscopic display technology developed at Xerox PARC and marketed by Gyricon Media (www.gyriconmedia.com), as “SmartPaper™.” SmartPaper™ is flexible like traditional paper, and is described in detail on their web page http://www.qyriconmedia.com/SmartPaper.asp, the content of which is fully incorporated herein by reference.

Another reflective display technology for use in embodiments of the invention programmable display 60 includes variants of flexible liquid crystal displays (“LCDs”). By way of example, according to an article found at www.electronicstimes.com/story/OEG20011108S0004, Omron Corp. (of Japan) has developed technology used to produce LCDs that can be folded and bent. According to another article published found at www.eetimes.com/story/OEG20010829S0065, Philips has developed a 64×64-pixel, passive-matrix reflective, cholesteric LCD, developed to offer ultra thin, flexible displays. Further, according to information found at www.creativepro.com/story/news/16653.html?cprose+3−22, Toshiba Corporation has announced it has developed a large flexible LCD that will provide for the display of images on curved screens and, eventually, foldable liquid crystal displays. The contents of each of the above web links and articles are fully incorporated herein by reference.

Thus, thin, flexible displays have been developed in the lab, and have potential to become mass market products. For example, see “Bending the Rules, on pages 20/24 of the March 2003 issue of Information Displays, which is fully incorporated herein by reference. Common to all such displays is the need for suitable thin flexible substrate materials. As noted in this reference, both polymer and constructions including glass films with thickness from 30 to 150 μm have been developed for this purpose. If a display with a large number of independently controlled pixels is desired, this reference notes that suitable active-matrix backplanes are required as well as being feasible using amorphous-Silicon structures as well as organic semiconductors. Regarding the nature of the electro-optical image elements, many options are available. This particular reference considers LCDs, OLED displays, and electrophoretic displays as leading candidates for flexible display technologies.

The foregoing detailed description includes passages that are chiefly or exclusively concerned with particular features or aspects of particular embodiments of the invention. It should be understood that this is for clarity and convenience, and that a particular feature may be relevant in more than just the passage in which it is disclosed and embodiment in which it is described. Similarly, although the various figures and descriptions herein relate to specific embodiments of the invention, it is to be understood that where a specific feature is disclosed in the context of a particular figure or embodiment, such feature may also be used, to the extent appropriate, in the context of another figure or embodiment, in combination with another feature, or in the invention in general.

1. A touchscreen, comprising:
a substrate having a first conductive region on a top surface thereof; and
a coversheet having a second conductive region on a bottom surface thereof, the coversheet bottom surface facing and spaced apart from the substrate top surface, the coversheet further comprising a programmable display,
the coversheet sufficiently flexible that a force applied to the coversheet causes the first and second conductive regions to make electrical contact in a location proximate the applied force.

2. The touchscreen of claim 1, the coversheet sufficiently resilient that, in an absence of any force applied to the coversheet, no electrical contact is made between the first and second conductive regions.

3. The touchscreen of claim 1, in which a voltage gradient is applied to the first conductive region for a first position coordinate measurement, and a voltage gradient is applied to the second conductive region for a second position coordinate measurement.

4. The touchscreen of claim 1, in which a first voltage gradient is applied to the first conductive region for a first position coordinate measurement and a second voltage gradient is applied to the first conductive region for a second position coordinate measurement.

5. The touchscreen of claim 4, further comprising diodes connected to the first conductive region.

6. The touchscreen of claim 1, wherein the programmable display is a video display.

7. The touchscreen of claim 1 wherein the programmable display is an emissive display.

8. The touchscreen of claim 7, the display comprising one or more organic light-emitting diodes (“OLEDs”).

9. The touchscreen of claim 8, the coversheet comprising a flexible polymer substrate on which the one or more OLEDs are fabricated.

10. The touchscreen of claim 8, the coversheet comprising a flexible glass substrate on which the one or more OLEDs are fabricated.

11. The touchscreen of claim 10, the glass substrate having a thickness of about 200 microns or less.

12. The touchscreen of claim 1, wherein the programmable display is a reflective display.

13. The touchscreen of claim 12, the display comprising electronic paper.

14. The touchscreen of claim 1, the coversheet top surface comprising a substantially transparent protective polymer layer.

15. The touchscreen of claim 14, the protective polymer layer configured for use as a writing surface.

16. The touchscreen of claim 14, wherein the protective polymer layer is removable.

17. The touchscreen of claim 1, one or both of the first and second conductive regions comprising an opaque material.

18. The touchsceen of claim 1, one or both of the first and second conductive regions comprising a conductive polymer coating.

19. A touchscreen, comprising:
a substrate having a top surface;
a coversheet having a bottom surface and a top surface, the coversheet bottom surface facing the substrate top surface;
a first conductive coating provided on the substrate top surface;
a second conductive coating provided on the coversheet bottom surface; and
a programmable display configured to generate images visible from the coversheet top surface,
the coversheet sufficiently flexible that a force applied to the coversheet top surface causes the first and second conductive coatings to make electrical contact in a location proximate the applied force.

20. The touchscreen of claim 19, further comprising control circuitry configured to identify two dimensional coordinates of the location of a force applied to the coversheet.

21. The touchscreen of claim 19, the display comprising organic light-emitting diodes.

22. The touchscreen of claim 19, the programmable display comprising electronic paper.

23. A touchscreen, comprising:
an interior touch sensor; and
an exterior programmable display positioned in registration with the touch sensor such that, when elements displayed by the display are touched, the touch sensor determines a two-dimensional position of the touch on the display.

24. The of touchscreen of claim 23, the touch sensor comprising
a substrate having a first conductive region on an exterior surface thereof, and
a coversheet having a second conductive region on an interior surface thereof, the coversheet interior surface facing and spaced apart from the substrate exterior surface,
wherein the coversheet is sufficiently flexible such that a touch to the display causes the first and second conducive regions to make electrical contact in a location proximate the touch.

25. The touchscreen of claim 23, wherein the programmable display is an emissive display.

26. The touchscreen of claim 23, wherein the programmable display is a reflective display.

27. The touchscreen of claim 25 or 26, wherein the programmable display is a video display.
